(19) United States
(12) Patent Application Publication
(10) Pub. No.: US 2025/0384283 A1
(43) Pub. Date: Dec. 18, 2025

(54) RAG PIPELINE OPTIMIZATION SYSTEM

(71) Applicant: Trustwise Inc., Austin, TX (US)

(72) Inventors: Manoj SAXENA, Austin, TX (US); Matthew BARKER, Edenbridge (GB); Avinash SAXENA, Katy, TX (US); Evan THOMAS, Durham (GB); James CARR, Northumberland (GB); Thomas ANDREWS, London (GB); Nihal BHATNAGAR, Austin, TX (US)

(21) Appl. No.: 19/229,879

(22) Filed: Jun. 5, 2025

Related U.S. Application Data
(60) Provisional application No. 63/661,519, filed on Jun. 18, 2024.

(51) Int. Cl. G06N 3/0895

(52) U.S. Cl. CPC G06N 3/0895

(57) ABSTRACT

According to an aspect of an embodiment, a method may include obtaining a blueprint associated with a retrieval-augmented generation (RAG) pipeline. The blueprint may define one or more objectives associated with the RAG pipeline. The method may further include performing an analysis of the RAG pipeline with respect to the one or more objectives. In some embodiments, one or more hyperparameters of the RAG pipeline may be adjusted based at least on the analysis.

### CROSS-REFERENCE TO RELATED APPLICATIONS

This patent Application claims priority to U.S. Provisional Application No. 63/661,519 filed Jun. 18, 2024, which provisional is incorporated herein by specific reference in its entirety.

### FIELD

The present invention relates to optimizing retrieval augmented generation (RAG) pipelines.

### BACKGROUND

Large language models (LLMs) are a class of machine learning models that are configured to understand and generate human-like text. LLMs are trained on vast amounts of text data to learn patterns, semantics, grammar, and context. LLMS are distinguished by sizes, defined by a large number of parameters. In general, as models get larger, the models are capable of learning more from training data, but larger sizes also require increased computational requirements. Different operations may be performed to optimize or improve the LLMs. LLM optimization focuses on making the LLMs more effective, efficient, and scalable.

The subject matter claimed herein is not limited to embodiments that solve any disadvantages or that operate only in environments such as those described above. Rather, this background is only provided to illustrate one example technology area where some embodiments described herein may be practiced.

### SUMMARY OF THE INVENTION

According to an aspect of an embodiment, a method may include obtaining a blueprint associated with a retrieval-augmented generation (RAG) pipeline. The blueprint may define one or more objectives associated with the RAG pipeline. The method may further include performing an analysis of the RAG pipeline with respect to the one or more objectives. In some embodiments, one or more hyperparameters of the RAG pipeline may be adjusted based at least on the analysis.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example RAG pipeline optimizing environment, in accordance with one or more embodiments of the present disclosure;

FIG. 2 illustrates an example RAG pipeline optimizing system, in accordance with one or more embodiments of the present disclosure;

FIG. 3 is a flow chart of an example method of RAG pipeline optimization process, in accordance with one or more embodiments of the present disclosure; and

FIG. 4 illustrates a block diagram of an example computing system that may be used with the optimizer system, in accordance with one or more embodiments of the present disclosure.

### DETAILED DESCRIPTION

Generative artificial intelligence (Gen AI) systems and models such as LLMs offer a wide range of benefits in various applications. The LLMs are configured to understand, generate, and process human language at a large scale. LLMs may understand the context, nuances, and complexities of human language such that the LLMs may interpret ambiguity and extract meaning from human-like text. The LLMs may generate human-like responses based on the data understood by the LLMs. The LLMs provide a convenient approach to consuming data by enhancing productivity, improving personalization, and automating tasks that may be labor-intensive.

As the applicability of LLMs increases over various fields, the importance of optimizing the LLMs also increases. Optimizing LLMs refers to the process of improving the performance, efficiency, and scalability of the LLMs, such that the LLMs are more practical for deployment in real-world applications. Optimization processes may be applied in various aspects such as computational efficiency, memory usage, inference speed, and model accuracy. Retrieval Augmented Generation (RAG) has emerged as a popular technique for improving or optimizing the LLMs on question-answering tasks over specific datasets. RAG pipelines may be used to combine the benefits of retrieval-based systems and generative models. For instance, RAG pipelines may incorporate external knowledge during inference, such that the LLM does not need to know everything upfront. The RAG may permit the LLM to retrieve the most relevant data dynamically, such that the LLM may generate answers based on real-time data.

However, the end-to-end pipeline of a RAG system is dependent on various parameters that span different components and/or modules of the system, such as the choice of LLM, the embedding model used in retrieval, the number of chunks retrieved and hyperparameters governing a reranking model. The performance of a RAG pipeline is dependent on such parameters individually and combinedly. Finetuning such parameters manually to achieve optimized performance may be difficult and/or costly. For instance, optimizing hyperparameters may require extensive time and resources. The hyperparameters may refer to values or configurations that control the behavior of the model and the training process. For example, the hyperparameters may include learning rate, batch size, number of epochs, number of layers, regularization parameters, optimizer type, momentum, activation function, etc. Despite the importance of hyperparameters in the RAG pipelines, a method of collectively optimizing the hyperparameters in a given RAG pipeline and a LLM is lacking.

According to one or more embodiments of the present disclosure, a system may be configured to perform optimization of a RAG pipeline. In particular, the system may be configured to perform multi-objective optimization over a unique set of hyperparameters of a RAG pipeline. In some embodiments, the objectives may include different goals or requirements associated with the RAG pipeline or the LLM. For example, the objectives may include cost, latency, safety, and alignment, among others. In these and other embodiments, the multi-objective optimization may include defining the set of hyperparameters such that the objectives for different systems may be met. For example, different LLMs and/or implementations may have different objectives. The hyperparameters may be optimized with respect to the different objectives.

In some embodiments, the system may be configured to scan and/or examine one or more Gen AI models, such as LLMs, to determine how suitable different models are for a particular user or a task. For example, in some embodiments, the system may be configured to scan the Gen AI models with respect to different objectives to determine how suitable the Gen AI models are for different users or tasks with respect to the different objectives.

Embodiments of the present disclosure will be explained with reference to the accompanying drawings.

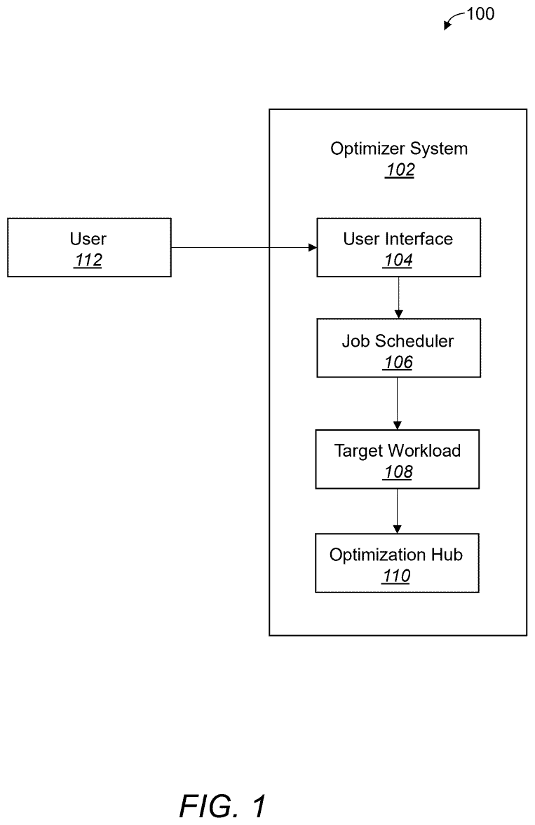

FIG. 1 illustrates an example Gen AI and/or Gen AI RAG pipeline optimizing environment 100, in accordance with one or more embodiments of the present disclosure. In some embodiments, the environment 100 may include an optimizer system 102. In some embodiments, the optimizer system 102 may include a user interface 104, a job scheduler 106, a target workload 108, and/or an optimization hub 110.

In some embodiments, the user interface 104 may include any device and/or system that may allow a user 112 to communicate with the optimizer system 102. For example, the user interface 104 may include a platform in which the user 112 may interact with AI models, monitor performances, and/or provide feedback. The user interface 104 may be formatted in any suitable way to provide the platform to the user 112. For example, the platform may be provided as an application, a web application, among others. In some embodiments, the user 112 may provide, via the user interface 104, AI optimization configurations to be run. For example, the user 112 may specify types of AI optimization operations to be performed by the optimizer system 102.

In some embodiments, the job scheduler 106 may be configured to manage and/or automate execution of tasks and/or jobs at specified times and/or under certain conditions. For example, the job scheduler 106 may be configured to schedule different optimization jobs, such as optimizing alignment, safety, cost, and/or latency of AI models. The job scheduler 106 may determine which AI optimization jobs to be performed and in which order to perform the AI optimization jobs based on the AI optimization configuration provided by the user 112.

In some embodiments, the job scheduler 106 may send the scheduled jobs and/or operations to access the target workload 108. In some embodiments, the target workload 108 may include different Gen AI systems and/or RAG pipelines that may be optimized and/or other user specified data such as training data. In the present disclosure, a reference to a Gen AI system or a model may include a reference to a RAG pipeline and vice versa.

In some embodiments, the target workload 108 and the AI optimization configurations may be provided to the optimization hub 110. In some embodiments, the optimization hub 110 may be configured to run and deploy the AI optimization jobs such as optimizing alignment, safety, and/or performance. For example, the optimization hub 110 may include one or more modules and/or systems that may observe, analyze, and/or optimize the AI systems.

Modifications, additions, or omissions may be made to the environment 100 without departing from the scope of the present disclosure. For example, in some embodiments, the environment 100 may include any number of other components that may not be explicitly illustrated or described. Further, depending on certain implementations, the environment 100 may not include one or more of the components illustrated and described.

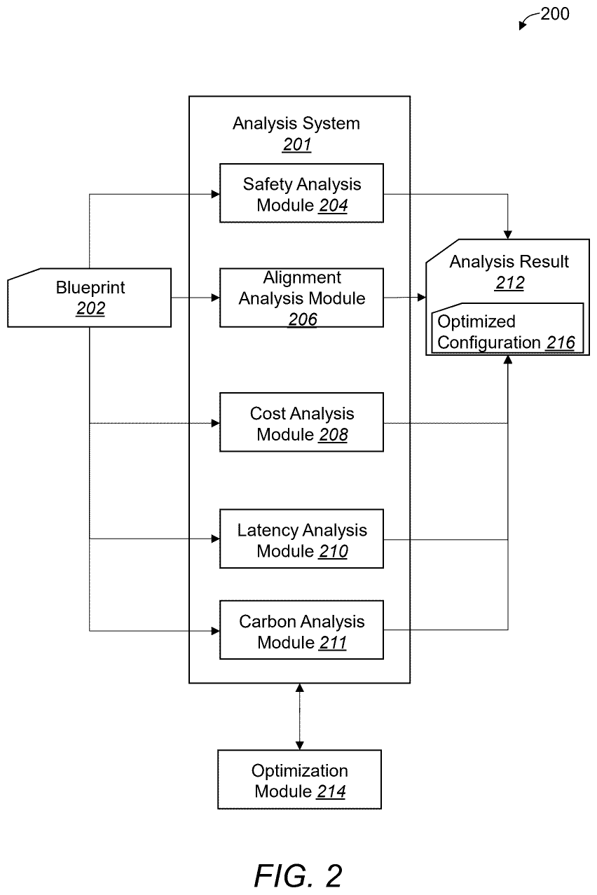

FIG. 2 illustrates an example optimization system 200 configured to adjust or optimize hyperparameters for a RAG pipeline, in accordance with one or more embodiments of the present disclosure. In some embodiments, the optimization system 200 may be configured to optimize one or more hyperparameters of a RAG pipeline. In these and other embodiments, the hyperparameters may refer to predefined configuration settings that control the behavior of retrieval and generation of the RAG pipeline. The hyperparameters are not learned during the training of the RAG pipeline but are set before training or deployment. The hyperparameters may influence the efficiency, accuracy, and/or quality of the results produced by the RAG pipeline. Some examples of the hyperparameters may include top-k retrieved document context chunks, max context chunk size, choice of retriever models, embedding vector dimensions temperature, choice of language models, top-k sampling, beam widths, among others.

In some embodiments, the optimization system 200 may be configured to analyze a blueprint 202. In some embodiments, the blueprint 202 may refer to a set of information defining a particular project or usage of the RAG pipeline. For example, the blueprint 202 may include data (e.g., documents, embedding models), policies and controls (e.g., different policies applicable to the particular project), evaluations (e.g., metric thresholds for metrics selected under policies and controls), infrastructure (e.g., provider, processor, region, etc.), blueprint details (e.g., industry, workload, etc.), models (e.g., LLMs), queries (e.g., baseline configuration used to generate synthetic queries for optimization evaluation), etc.

In some embodiments, the optimization system 200 may analyze the blueprint 202 with respect to one or more evaluations. The evaluations may refer to metrics and/or metric thresholds that may be used to define and/or control the RAG pipeline. For example, the evaluations may be performed with respect to safety, alignment, cost and latency. The optimization system 200 may include an analysis system 201 including one or more modules corresponding to the evaluations. For example, the analysis system 201 may include a safety analysis module 204, an alignment analysis module 206, a cost analysis module 208, a latency analysis module 210, and a carbon analysis module 211. In these and other embodiments, the one or more modules may be configured to scan the AI models included in the blueprint 202 with respective evaluations. While described with the safety analysis module 204, the alignment analysis module 206, the cost analysis module 208, and the latency analysis module 210, the optimization system 200 may include any other suitable types of analysis module associated with other evaluation categories.

In these and other embodiments, the blueprint 202 may include the standards or configurations of the modules. For example, the blueprint 202 may define different standards that are applicable with respect to safety, alignment, cost, and latency. The modules may be configured to scan the AI models included or listed in the blueprint 202 with respect to the applicable standards.

For example, the safety analysis module 204 may be configured to scan and analyze the AI models with respect to one or more safety standards included in the blueprint 202. In the present application, the term safety may refer to hallucination risks, or the risk that a RAG pipeline returns false or unverifiable information or generates responses that are factually inaccurate. In some embodiments, the safety analysis module 204 may be configured to scan the different AI models included in the blueprint 202 with respect to different specifications of the blueprint 202. For example, the safety analysis module 204 may be configured to analyze the AI models with respect to different evaluation metrics associated with safety. For example, the safety analysis module 204 may analyze the AI models for hallucinations (e.g., context relevancy, answer relevancy, summarization, faithfulness, etc.) and security (e.g., data leakage, prompt injection, etc.).

The alignment analysis module 206 may be configured to analyze the AI models included in the blueprint 202 with respect to alignment. The alignment may refer to how useful, detailed and/or unambiguous a response is. For example, the alignment may refer to how well the responses answer the questions or commands provided to the AI models. In some embodiments, the alignment analysis module 206 may analyze the AI models with respect to different standards or metrics. For example, the alignment analysis module 206 may analyze the AI models with respect to toxicity, clarity, tone, formality, helpfulness, and simplicity, among others.

In some embodiments, the safety analysis module 204 and the alignment analysis module 206 may perform the analysis of the AI models based on the responses of the AI models. For example, the AI models may be configured to generate responses based on a query. The responses may be analyzed to determine how the AI models perform with respect to safety and/or alignment.

In these and other embodiments, the safety metric thresholds and the alignment metric thresholds may be defined to set constraints for optimization. For example, the metric thresholds may define certain thresholds or goals for AI models to meet for optimization. For example, the AI models may be analyzed to determine types and amounts of work to be performed such that the AI models meet the metric thresholds.

In some embodiments, the analysis results from the safety analysis module 204 and/or the alignment analysis module 206 may be represented as corresponding scores. For example, the safety analysis module 204 may generate a safety score for each AI model. In some embodiments, the safety score may be a number within a certain range with a higher number or score representing safer responses or AI models. The alignment analysis module 206 may generate an alignment score for each AI model. In some embodiments, the alignment score may be a number within a certain range with higher number or score representing more aligned responses or AI models

In some embodiments, the cost analysis module 208 may be configured to determine or calculate the cost of an evaluation (e.g., evaluation of a response and/or an AI model with respect to safety and/or alignment). The cost analysis module 208 may calculate the cost based on costs associated with various components of a RAG pipeline. For example, the cost may be determined based on the query embedding cost, reranker embedding cost, LLM input token cost, LLM output token cost, etc.

The latency analysis module 210 may be configured to determine or calculate the latency associated with the RAG pipeline. The latency may refer to the time taken for a complete end-to-end run of the RAG pipeline, from the moment an initial query is sent to the system to the moment a full response is returned to the user.

In some embodiments, the carbon analysis module 211 may be configured to calculate carbon emissions associated with the RAG pipeline. The RAG pipelines may generate carbon emissions through electricity consumption during computation. Each stage in the pipeline utilizes hardware (e.g., CPUs, GPUs, memory, storage, etc.) which draws power from data centers and/or local machines. Generally, such power comes from carbon-emitting energy sources, leading to carbon emissions. The carbon analysis module 211 may be configured to calculate the carbon emissions based on certain standards. For example, the carbon analysis module 211 may calculate carbon emissions based on software carbon intensity (SCI) ISO 21031. The SCI ISO 21031 may provide a standardized method to calculate and report the carbon intensity of software systems. While described with respect to a particular standard, the carbon analysis module 211 may calculate the carbon emissions based on any other suitable standards or methods.

In some embodiments, the analysis system 201 may be configured to generate an analysis result 212 based on the analyses by the safety analysis module 204, the alignment analysis module 206, the cost analysis module 208, the latency analysis module 210, and the carbon analysis module 211. In some embodiments, the analysis results 212 may be provided in different formats and/or methods.

In some embodiments, the analysis system 201 may be configured to perform multiple iterations of the analysis. The multiple iterations may be run to test different combinations of hyperparameters of a RAG pipeline. For example, the multiple iterations may have different combinations of models (e.g., LLMs), embedding models, chunk size (e.g., 256, 512, 1024, etc.), number of chunks (e.g., 2, 4, 8, etc.), prompt engineering, etc. In these and other embodiments, any other suitable hyperparameters may be included as part of the combinations. In some embodiments, certain controlled variables such as data (e.g., document uploaded to be queried against) and infrastructure (e.g., cloud provider, processor, region, etc.) may remain the same, such that different combinations of the hyperparameters may be tested in the same environment.

In some embodiments, the analysis system 201 may be configured to run each iteration of analysis to produce the analysis result 212 for each iteration. The analysis result 212 for each iteration may represent how different combinations of the hyperparameters affect certain dependent variables. For example, each iteration may produce values for controls (e.g., safety, alignment, cost, carbon, latency, etc.) and compliance assessments for different policies, including internal policies and external policies. For example, the safety analysis module 204, the alignment analysis module 206, the cost analysis module 208, and the latency analysis module 210 may each run the respective analysis for each iteration.

In some embodiments, the optimization system 200 may include an optimization module 214. The optimization module 214 may be configured to communicate with the analysis system to specify the different combinations of the hyperparameters. For example, the optimization module 214 may be configured to attempt to optimize (e.g., minimize and/or maximize) the analysis result 212 by changing the values of the hyperparameters. In some embodiments, the optimization module 214 may be configured to define the different combinations of the hyperparameters using different techniques or approaches. For example, in some embodiments, the optimization module 214 may utilize Bayesian optimization. Bayesian optimization is a technique used for optimizing complex objective functions of hyperparameters. The objective function may represent the function that the optimization module 214 is trying to optimize. Setting an appropriate objective function (e.g., composite performance or a combined score from Safety, Alignment and Performance metrics) may help the Bayesian optimization process to understand the relationships between different hyperparameters and the objective function.

In some embodiments, the analysis result 212 may be presented to the user. In some embodiments, the analysis result 212 may be presented through calculators, alerts, and reports dashboards (CARD). The CARD may include different tables and/or reports, modifiable based on the audience or the user.

In some embodiments, the analysis result 212 may be illustrated to illustrate the scan progress and results of each iteration of analysis. For example, the CARD may include an optimization summary including details such as max scores for safety, alignment, and performance metrics across different iterations. In some embodiments, the max scores may be represented with respect to different AI models or LLM used. Additionally or alternatively, the CARD may include a financial cost scatter plot, representing the relationships between cost and composite performance (e.g., a combination of functional performance, safety, and alignment).

The analysis result 212 may include token and cost reduction scenarios. For example, the analysis result 212 may illustrate certain scenarios having different project costs. For example, the analysis result 212 may include breakdown of project costs for baseline (without optimization), no routing or caching (with optimization), caching only (with optimization), and routing and caching (with optimization). Additionally or alternatively, the analysis result 212 may include a radar chart illustrating a comparison between a baseline and an optimized iteration (of hyperparameters). For example, the radar chart may illustrate comparisons between the baseline and the optimized iteration with respect to cost efficiency, carbon emitted, latency efficiency, safety, and alignment, among others.

In some embodiments, the analysis result 212 may include a comparative model performance leaderboard. The leaderboard may illustrate details of each iteration. For example, the leaderboard may illustrate granular results for each iteration, such as with respect to SCI scores, latencies, RAG configurations, safety and alignment metrics. Any other suitable types of approaches and/or methods may be used to illustrate the analysis results.

For example, in some embodiments, the analysis results 212 may be illustrated as line-of-defense (LOD) reports. LOD reports refer to documents or analyses used in risk management, security, compliance, and/or organizational governance. The LOD reports may outline different levels of defense or control measures that an organization has to prevent, detect, or mitigate risks, threats, and/or vulnerabilities. The LOD reports may have different lines of defenses having multiple layers of protection against risks.

The first LOD report may include a table of information for each module, such as the safety analysis module 204, the alignment analysis module 206, the cost analysis module 208, and the latency analysis module 210. Additionally or alternatively, the modules may include modules configured to measure speed of the iterations and/or a module configured to calculate carbon emissions for different iterations. The first LOD report may lay out different information for each module, including metrics, results, thresholds, descriptions, etc.

The second LOD report may represent risk and compliance. For example, the second LOD report may include different metrics or compliances that may be applicable to the project. The compliances of the blueprint and/or the iterations may be illustrated. Further, different types of risks associated with the project and/or the blueprint may be identified. In these and other embodiments, the second LOD report may include the identified risks with possible risk mitigation actions. In some embodiments, the second LOD report may include crosswalk evaluations illustrating evaluations for each iteration for policy compliance against the user-selected policies.

The third LOD report may represent audit and finance. For example, the third LOD report may include tables of metrics related to audit and finance. The audit may be associated with metrics and compliances with respect to safety and alignment. The finance may be associated with metrics and compliances with respect to cost and carbon. In some embodiments, the third LOD report may include a cost and performance chart detailing cost against metric performance for each metric. In some embodiments, the third LOD report may include a financial cost scatter plot illustrating cost against composite performance.

In some embodiments, the LOD reports and/or the analysis result 212 may include user query distribution. The user query distribution may include a visualization representing results of a system configured to improve responses of AI models to be safe and aligned. For example, the visualization may represent the process and/or outcomes of running one or more optimization systems (e.g., the optimization system 200). The visualization may represent numbers and/or portions of queries from all user queries that are acceptable, valid, and/or aligned.

In some embodiments, the analysis result 212 may include optimized configurations 216. The optimized configurations 216 may include a set of hyperparameters that are optimal for a set of metrics. For example, the optimized configurations 216 may define the set of hyperparameters that satisfy different requirements of a particular project with respect to different metrics related to safety, alignment, cost, carbon, latency, etc. In some embodiments, the optimized configurations 216 may be loaded to a RAG pipeline to set up the RAG pipeline based on the optimized configurations 216. Loading the optimized configurations 216 may allow the user to set up a RAG pipeline that is suitable for the particular project.

In some embodiments, the analysis result 212 may include a set of recommended iterations and/or configurations on the Pareto-optimal front. Pareto-optimal front is a concept in multi-objective optimization, used to describe the set of optimal trade-offs between competing objectives. For example, in instances with two or more conflicting objectives, a solution is Pareto-optimal if no other solution can improve one objective without worsening another objective. In these and other embodiments, selecting a set of configurations and/or iterations not in the set of recommended iterations and/or configurations may not be optimal and/or recommended, as in general, the configurations and/or iterations in the set of recommended iterations are more likely to provide comparatively better results.

In some embodiments, the AI models used in the RAG pipeline may go through a fine-tuning process. The fine-tuning process may include the process of enhancing the training data of an AI model with use-case specific examples of responses which better reflect the desired outcomes. Such examples may alter the likelihood of an AI model selecting and generating various tokens, with the desired outcomes becoming more likely to be chosen over others. In some embodiments, different types of suitable fine-tuning approaches or methods may be used. For example, Kahneman-Tversky Optimization (KTO) may be used.

In some embodiments, different actions or methods may be taken to increase the efficiency of a RAG pipeline. For example, in some embodiments, a cache may be created to store responses to frequently asked questions. The cache may help increase the efficiency of the RAG pipeline, lowering overall cost and latencies.

Modifications, additions, or omissions may be made to the optimization system 200 without departing from the scope of the present disclosure. For example, in some embodiments, the optimization system 200 may include any number of other components that may not be explicitly illustrated or described. Further, depending on certain implementations, the environment 100 may not include one or more of the components illustrated and described.

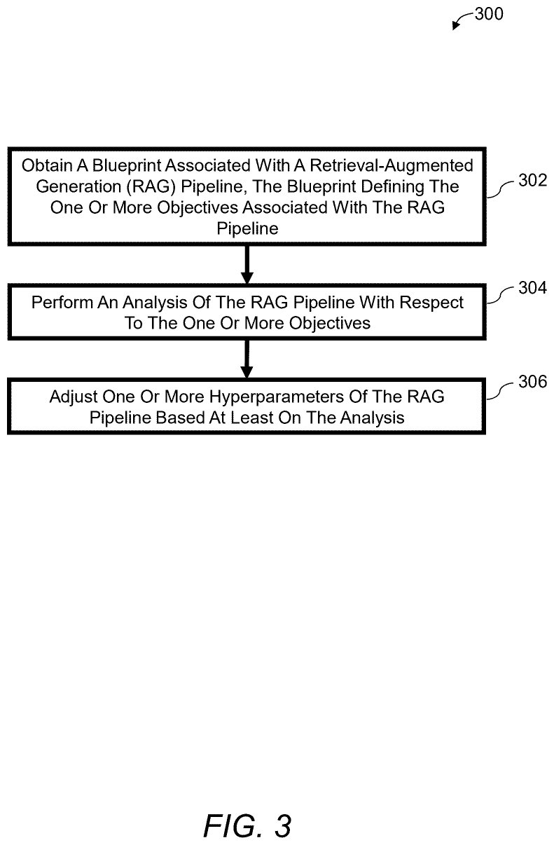

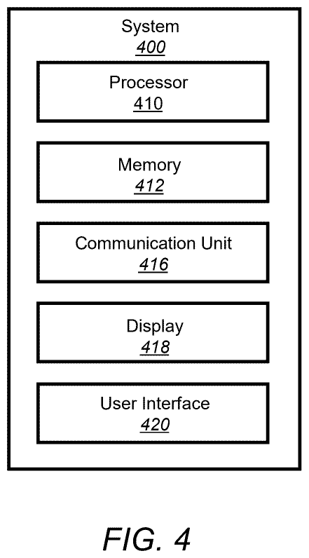

FIG. 3 is a flow chart of an example method 300 of a RAG pipeline optimization process, arranged in accordance with at least one embodiment of the present disclosure. One or more operations of the method 300 may be implemented by any suitable systems such as the optimizer system 102 of FIG. 1, the optimization system 200 of FIG. 2, and/or the computing system 400 of FIG. 4. Although illustrated as discrete steps, various steps of the method 300 may be divided into additional steps, combined into fewer steps, or eliminated, depending on the desired implementation. Additionally, the order of performance of the different steps may vary depending on the desired implementation.

In some embodiments, the method 300 may include block 302. At block 302, a blueprint associated with a retrieval-augmented generation (RAG) pipeline may be obtained. In some embodiments, the blueprint may define one or more objectives associated with the RAG pipeline. In some embodiments, the objectives may include one or more standards for the pipeline. The one or more standards may define specifications and/or requirements for the RAG pipeline that a particular user or project requires. In some embodiments, the one or more objectives may include one or more standards associated with safety, alignment, cost, and/or latency.

In some embodiments, the blueprint may further define one or more generative artificial intelligence (Gen AI) models to be analyzed. For example, the blueprint may define different LLMs that may be used for the particular project or by the user.

At block 304, an analysis of the RAG pipeline may be performed with respect to the one or more objectives. In some embodiments, the analysis may include generating one or more scores, in which each score of the one or more scores corresponds to the one or more objectives. For example, in instances in which the one or more objectives are associated with safety, alignment, cost, and/or latency, the one or more scores may include a safety score and an alignment score. In some embodiments, a report may be generated including the one or more scores. In some embodiments, analysis may include scanning the one or more Gen AI models with respect to the one or more objectives. For example, the Gen AI models may be scanned for performances with respect to safety and/or alignment. Additionally, the Gen AI models may be scanned to identify cost and/or latency associated with the operations of the Gen AI models.

At block 306, one or more hyperparameters of the RAG pipeline may be adjusted based at least on the analysis. In some embodiments, the one or more hyperparameters may be adjusted such that the RAG pipeline is optimized with respect to the one or more objectives. In these and other embodiments, optimizing the RAG pipeline may refer to adjusting the parameters such that certain scanning results of the RAG pipeline are maximized and/or minimized. For example, the hyperparameters may be adjusted such that the safety scores may be maximized, and the cost is minimized. In these and other embodiments, maximizing and minimizing may refer to getting closer to different thresholds. For example, the RAG pipeline may be associated with a particular safety threshold or a safety score. In such instances, maximizing the safety scores may refer to adjusting the hyperparameters such that the safety score gets closer to the safety threshold.

In some embodiments, adjusting the one or more hyperparameters may include performing a optimization process with respect to the one or more objectives with the one or more hyperparameters as independent variables. In these and other embodiments, any types of suitable optimization methods and/or processed may be used. For example, Bayesian optimization may be used to adjust the hyperparameters. The Bayesian optimization may adjust the independent variables (e.g., the hyperparameters) such that the hyperparameters are optimized. In these and other embodiments, the independent variables may be adjusted based on the Bayesian optimization.

In some embodiments, multiple iterations of the analysis of the RAG pipeline may be performed. In these and other embodiments, each iteration may analyze or test different configurations of the RAG pipeline. For example, the independent variables or the hyperparameters of the RAG pipeline may be adjusted for each iteration of the analysis.

Modifications, additions, or omissions may be made to the method 300 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 300 may include performing a second analysis of the RAG pipeline based on the adjusted hyperparameters. In some embodiments, the adjusted hyperparameters may be further adjusted based at least on the second analysis. In some embodiments, the further adjustment may include finetuning the AI models included in the RAG pipeline.

FIG. 4 is a block diagram illustrating an example system 400 that may be used for RAG pipeline optimization, according to at least one embodiment of the present disclosure. The system 400 may include a processor 410, memory 412, a communication unit 416, a display 418, and a user interface unit 420, which all may be communicatively coupled. In some embodiments, the system 400 may be used to perform one or more of the methods described in this disclosure.

For example, the system 400 may be used to assist in the performance of the method described in FIG. 3. For example, the system 400 may be used to implement the optimization process of the method 300.

Generally, the processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 410 may include any number of processors distributed across any number of networks or physical locations that are configured to perform individually or collectively any number of operations described herein. In some embodiments, the processor 410 may interpret and/or execute program instructions and/or process data stored in the memory 412. In some embodiments, the processor 410 may execute the program instructions stored in the memory 412.

For example, in some embodiments, the processor 410 may execute program instructions stored in the memory 412 that are related to task execution such that the system 400 may perform or direct the performance of the operations associated therewith as directed by the instructions. In these and other embodiments, the instructions may be used to perform one or more blocks of method 300 of FIG. 3.

The memory 412 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 410.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 410 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 400 F.3d 1346 (Fed. Cir. 2007). Combinations of the above may also be included within the scope of computer-readable media.

The communication unit 416 may include any component, device, system, or combination thereof that is configured to transmit or receive information over a network. In some embodiments, the communication unit 416 may communicate with other devices at other locations, the same location, or even other components within the same system. For example, the communication unit 416 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 416 may permit data to be exchanged with a network and/or any other devices or systems described in the present disclosure.

The display 418 may be configured as one or more displays, like an LCD, LED, Braille terminal, or other type of display. The display 418 may be configured to present video, text captions, user interfaces, and other data as directed by the processor 410.

The user interface unit 420 may include any device to allow a user to interface with the system 400. For example, the user interface unit 420 may include a mouse, a track pad, a keyboard, buttons, camera, and/or a touchscreen, among other devices. The user interface unit 420 may receive input from a user and provide the input to the processor 410. In some embodiments, the user interface unit 420 and the display 418 may be combined.

Modifications, additions, or omissions may be made to the system 400 without departing from the scope of the present disclosure. For example, in some embodiments, the system 400 may include any number of other components that may not be explicitly illustrated or described. Further, depending on certain implementations, the system 400 may not include one or more of the components illustrated and described.

As indicated above, the embodiments described herein may include the use of a special purpose or general-purpose computer (e.g., the processor 410 of FIG. 4) including various computer hardware or software modules, as discussed in greater detail below. Further, as indicated above, embodiments described herein may be implemented using computer-readable media (e.g., the memory 412 of FIG. 4) for carrying or having computer-executable instructions or data structures stored thereon.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining a blueprint associated with a retrieval-augmented generation (RAG) pipeline, the blueprint defining one or more objectives associated with the RAG pipeline;
performing an analysis of the RAG pipeline with respect to the one or more objectives; and
adjusting one or more hyperparameters of the RAG pipeline based at least on the analysis.

2. The method of claim 1, wherein performing the analysis of the RAG pipeline with respect to the one or more objectives comprises:
generating one or more scores, each score of the one or more scores corresponding to the one or more objectives.

3. The method of claim 2, wherein performing the analysis of the RAG pipeline with respect to the one or more objectives further comprises:
generating a report including the one or more scores.

4. The method of claim 1, wherein the one or more objectives include one or more standards for the RAG pipeline.

5. The method of claim 1, wherein the one or more objectives include one or more of safety, alignment, cost, carbon or latency.

6. The method of claim 1, wherein the blueprint further defines one or more generative artificial intelligence (Gen AI) models to be analyzed.

7. The method of claim 6, wherein performing analysis of the RAG pipeline with respect to the one or more objectives comprises:
scanning the one or more Gen AI models with respect to the one or more objectives.

8. The method of claim 1, wherein adjusting one or more hyperparameters of the RAG pipeline based at least on the analysis comprises:
performing a optimization process with respect to the one or more objectives with the one or more hyperparameters as independent variables; and
adjusting the independent variables based on the optimization process.

9. The method of claim 1, further comprising:
performing a second analysis of the RAG pipeline based on the adjusted hyperparameters; and
further adjusting the adjusted hyperparameters based at least on the second analysis.

10. The method of claim 1, wherein a plurality of iterations of the analysis of the RAG pipeline is performed, each iteration of the plurality of iterations analyzing different configuration of the RAG pipeline.

11. A system comprising:
one or more processors; and
one or more non-transitory computer-readable storage media configured to store instructions that, in response to being executed, cause a system to perform operations, the operations comprising:
obtaining a blueprint associated with a retrieval-augmented generation (RAG) pipeline, the blueprint defining one or more objectives associated with the RAG pipeline;
performing an analysis of the RAG pipeline with respect to the one or more objectives; and
adjusting one or more hyperparameters of the RAG pipeline based at least on the analysis.

12. The system of claim 11, wherein performing the analysis of the RAG pipeline with respect to the one or more objectives comprises:
generating one or more scores, each score of the one or more scores corresponding to the one or more objectives.

13. The system of claim 12, wherein performing the analysis of the RAG pipeline with respect to the one or more objectives further comprises:
generating a report including the one or more scores.

14. The system of claim 11, wherein the one or more objectives include one or more standards for the RAG pipeline.

15. The system of claim 11, wherein the one or more objectives include one or more of safety, alignment, cost, or latency.

16. The system of claim 11, wherein the blueprint further defines one or more generative artificial intelligence (Gen AI) models to be analyzed.

17. The system of claim 16, wherein performing analysis of the RAG pipeline with respect to the one or more objectives comprises:
scanning the one or more Gen AI models with respect to the one or more objectives.

18. The system of claim 11, wherein adjusting one or more hyperparameters of the RAG pipeline based at least on the analysis comprises:
performing a optimization process with respect to the one or more objectives with the one or more hyperparameters as independent variables; and
adjusting the independent variables based on the optimization process.

19. The system of claim 11, the operations further comprising:
performing a second analysis of the RAG pipeline based on the adjusted hyperparameters; and
further adjusting the adjusted hyperparameters based at least on the second analysis.

20. One or more non-transitory computer-readable media storing instructions that, when executed by one or more processors, cause a system to perform operations, the operations comprising:
obtaining a blueprint associated with a retrieval-augmented generation (RAG) pipeline, the blueprint defining one or more objectives associated with the RAG pipeline;
performing an analysis of the RAG pipeline with respect to the one or more objectives; and
adjusting one or more hyperparameters of the RAG pipeline based at least on the analysis.
